(19) United States
(12) Patent Application Publication
(10) Pub. No.: US 2025/0165304 A1
(43) Pub. Date: May 22, 2025

(54) SYSTEMS AND METHODS FOR PROVIDING FAIR ALLOCATION OF SHARED CAPACITY IN MULTI-TENANT RESOURCE ENVIRONMENTS

(71) Applicant: Microsoft Technology Licensing, LLC, Redmond, WA (US)

(72) Inventors: Anthony Christopher KARLOFF, Waltham, MA (US); Grace Marie BRAMLEY-SIMMONS, Somerville, MA (US); Fahd Ahmad KAMAL, Sammamish, WA (US); Hemant KUMAR, Bellevue, WA (US); Wenbin MENG, Bellevue, WA (US)

(21) Appl. No.: 18/517,762

(22) Filed: Nov. 22, 2023

(51) Int. Cl. G06F 9/50

(52) U.S. Cl. CPC G06F 9/5077; G06F 2209/5011; G06F 2209/503; G06F 2209/504

(57) ABSTRACT

Systems and methods are disclosed herein for providing fair allocation of resources in a multi-tenant environment. Systems and methods are configured for identifying a plurality of tenants participating in the multi-tenant environment. For each tenant of the plurality of tenants, systems determine a tenant status as a donating tenant, a fairly borrowing tenant, or an unfairly borrowing tenant and apply a different borrowing algorithm to each tenant of the plurality of tenants based on a corresponding tenant status determined for each tenant. Different borrowing algorithms are configured to determine different resource borrowing limits from a common pool of resources for each tenant.

### BACKGROUND

Large Language Models (LLMs) are trained on vast amounts of text data and can generate coherent and contextually relevant sentences by predicting the likelihood of a word given the previous words used in the text. LLMs have a wide range of applications, including but not limited to text generation, translation, summarization, and question answering.

LLMs require substantial computational resources to operate, particularly Graphics Processing Units (GPUs), which are well-suited to the parallel processing tasks involved in training and running these models. The cost of these resources, both in terms of acquisition and operation, can be substantial. Therefore, maximizing the utilization of these resources is a priority for organizations that operate LLMs.

One approach to maximize resource utilization is through multi-tenancy, where multiple users or tenants share access to the same hardware resources. In such a multi-tenant environment, each tenant is typically allocated a certain amount of the total available hardware capacity. However, at any given time, some tenants may not use their full allocation, resulting in unused capacity.

Resource allocation in multi-tenant environments is a complex task. It involves ensuring that each tenant has access to their allocated resources while also allowing for the efficient use of any unused capacity. This requires a system that can track the active usage of resources, manage the allocation and de-allocation of resources, and ensure fair access to resources among tenants.

Various strategies and algorithms have been proposed for resource allocation in multi-tenant environments. These include queue-based fair sharing algorithms, time-sliced allocation algorithms, and max-min fairness algorithms. However, these algorithms have limitations and do not always provide the desired level of fairness or efficiency in resource utilization, particularly for contested resources in the context of LLMs.

Given the foregoing, there is a need for improved methods and systems that provide improved allocation of shared resources in a multi-tenant environment.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

The disclosed embodiments are directed toward systems and methods for managing shared resources in a multi-tenant environment. Generally, systems are configured for identifying a plurality of tenants participating in the multi-tenant environment. For each tenant of the plurality of tenants, systems determine a tenant's status as a donating tenant, a fairly borrowing tenant, or an unfairly borrowing tenant and apply a different borrowing algorithm to each tenant of the plurality of tenants based on a corresponding tenant status determined for each tenant.

Some embodiments include granting requests from tenants who are determined to be fairly borrowing tenants and denying requests from tenants who are determined to be unfairly borrowing tenants. Different borrowing algorithms are configured to determine different resource borrowing limits from a common pool of resources for each tenant depending on whether the tenants are determined to be fairly borrowing or unfairly borrowing.

More particularly, some embodiments are also directed to systems and methods for providing fair allocation of resources in a multi-tenant environment. For example, for each tenant of a plurality of tenants, systems first determine a fixed limit of resource capacity guaranteed to be available to each tenant. Systems also periodically evaluate each tenant to identify unused resources and assign the unused resources to a common pool.

Then systems calculate a fair borrowing limit of resources that each tenant is allocated to borrow from the common pool. The fair borrowing limit of resources is based at least in part on a proportional analysis of a percentage of resources currently borrowed by each tenant from the common pool compared to a percentage of the fixed limit of resource capacity guaranteed to be available to each tenant relative to a sum of all fixed limits of resources corresponding to the plurality of tenants. Systems determine, based on the proportional analysis, which of the plurality of tenants are fairly borrowing tenants (i.e., tenants who are fairly borrowing resources from the common pool) and which of the plurality of tenants are unfairly borrowing tenants (i.e., tenants who are unfairly borrowing resources from the common pool).

Systems then generate a new calculated borrowing limit of resources an unfairly borrowing tenant is allocated to borrow from the common pool which is less than the fair borrowing limit of resources that was previously calculated. Finally, in some instances, systems will reject a request from an unfairly borrowing tenant to borrow additional resources from the common pool upon determining the request from the unfairly borrowing tenant would cause an allocation of resources from the common pool to the unfairly borrowing tenant to exceed the new calculated borrowing limit.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments that are illustrated in the appended drawings. Understanding that these drawings depict only typical embodiments and are not, therefore, limiting in scope, embodiments will be described and explained with additional specificity and detail through the use of the accompanying drawings in which:

FIG. 1 illustrates one embodiment of a flow diagram having a plurality of acts associated with a method for providing shared allocation of resources in a multi-tenant resource environment.

FIG. 2 illustrates another example embodiment of a flow diagram having a plurality of acts associated with a method for providing shared allocation of resources in a multi-tenant resource environment.

FIG. 3 illustrates an example embodiment of shared resources in a multi-tenant environment.

FIG. 4 illustrates an example embodiment of fixed limits for each tenant in the multi-tenant resource environment.

FIG. 5 illustrates an example embodiment of assessing used versus unused capacity for donating resources to the common pool.

FIGS. 6-7 illustrate an example embodiment of fulfilling requests to borrow resources from the common pool.

FIG. 8 illustrates an example embodiment of determining tenant status.

FIG. 9 illustrates an example embodiment of determining resource allocation limits based on different tenant statuses.

FIG. 10 illustrates another example embodiment of determining tenant status.

FIG. 11 illustrates an example computing environment in which a computing system incorporates and/or is utilized to perform disclosed aspects of the disclosed embodiments.

### DETAILED DESCRIPTION

The disclosed embodiments can be utilized to facilitate improvements in the allocation of resources in a multi-tenant resource environment. In particular, systems and methods are included herein that apply different fairness algorithms for allocating resources between different tenants. As described above, one approach to maximize resource utilization is through multi-tenancy, where multiple users (e.g., client systems) or tenants share access to the same hardware resources. In such a multi-tenant environment, each tenant is typically allocated a certain amount of the total available hardware capacity.

A tenant, as described herein can comprise a single stand-alone computer system of a user, for example. In other instances, a tenant is a distributed network of computer systems, such as an enterprise system that includes multiple different stand-alone computer systems that are linked together and associated with the tenant entity comprising the enterprise.

At any given time, some tenants may not use their full allocation, resulting in unused capacity. Thus, the disclosed embodiments facilitate an improvement in resource utilization across all tenants participating in a shared resource environment. It should be appreciated that a tenant, in some instances, refers to a human user, while in other instances, a tenant is any computer-based user (e.g., a bot or software application) that utilizes resources. In some instances, the multi-tenant environment comprises human and computer-based tenants.

### Technical Benefits

As will be described in more detail herein, many technical problems exist with conventional systems allocating shared resources in a multi-tenant resource environment. Some of these technical problems are associated with conventional systems. For example, in time-sliced allocation systems where the CPU time is split into uniform time slices and allocated to each process in turn, a process runs for the time slice allocated and then pauses until a new time slice is allocated to it. However, this method relies on interruptible processes. In processing requests using LLMs, the requests cannot be interrupted (i.e., a tenant must be able to maintain the required amount of resources for the entire time that the system is processing the LLM request). Some conventional systems manage shared resources by allocating network bandwidth based on a fair slice of capacity to different tasks. However, when scoring a request on an LLM, a minimum amount of capacity must be reserved for the entire duration of the task, and oftentimes, the duration is not known at the time of resource capacity allocation. This problem is addressed by the allocation of resources in terms that are not restricted to time slices.

Some conventional resource management solutions attempt to address the problem of fairly allocating resources by maintaining more resources than are needed. However, this can result in wasted and underutilized resources. In light of the aforementioned technical problems, the disclosed embodiments are directed to technical solutions that can be used to help address fair resource allocation while also providing for maximum utilization, as will be described in more detail below.

For example, the disclosed embodiments are directed to systems and methods that provide a fair allocation of shared resource capacity across multiple tenants for LLMs with a near-real-time approach that ensures tenants have guaranteed access to their fixed limit and fair access to additional resources above their fixed limit. This is accomplished by tracking the active usage of capacity for tenants through leases, periodically evaluating tenants for unused capacity, maintaining a common pool of unused resources from which tenants can reclaim or borrow resources, and finally, forcing tenants to return borrowed capacity to the common pool when tenants below their fixed limit need more resources.

Any tenant, including unfairly borrowing tenants, is able to borrow from the common pool, thereby facilitating a maximum utilization of all resources available in the multi-tenant environment. However, while any tenant is able to borrow from the common pool, fair access to resources is achieved by reserving resources in the common pool for donating or fairly borrowing tenants (i.e., unfairly borrowing tenants will leave enough reserved capacity in the common pool for other tenants).

In summary, the disclosed embodiments provide many technical benefits associated with improved systems and methods for managing resources in a multi-tenant environment, such as providing a minimum guaranteed access to resources for each tenant, a maximum fair access to additional resources for each tenant based on a current utilization status, and maximum utilization of all resources across all tenants in the multi-tenant resource environment. The disclosed embodiments can also reduce request processing response time by the system when processing requests by the different tenants by ensuring that a minimum amount of resources will always be available for the different requesting tenants while also preventing unfairly borrowing tenants from starving the system of resources needed to process the requests of the different requesting tenants.

### Introduction

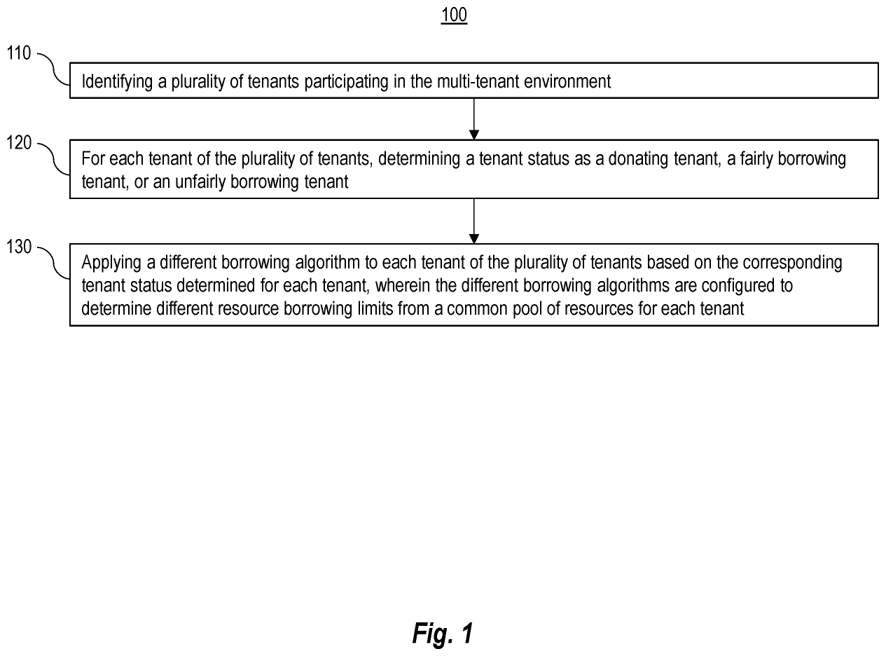

Attention will now be directed to FIG. 1, which illustrates a flow diagram or method 100 that includes various acts (act 110, act 120, and act 130) associated with exemplary methods that can be implemented by computing system 1110 for providing fair allocation of resources in a multi-tenant environment.

A first illustrated act is provided for identifying a plurality of tenants participating in the multi-tenant environment (act 110). For each tenant of the plurality of tenants, systems determine a tenant status as a donating tenant that is donating some or all of a fixed limit of resources guaranteed to be available to the particular tenant, a fairly borrowing tenant that is borrowing resources at or below a previously determine borrowing limit, or an unfairly borrowing tenant that is borrowing resources above a previously determined borrowing limit (act 120). By identifying whether a tenant is a donating tenant, a fairly borrowing tenant, or an unfairly borrowing tenant, the system is able to better determine the allocation or re-allocation of resources that are available to each tenant resulting in (i) the improved fair allocation between all the tenants and (ii) the optimization of the system to achieve maximum utilization of all resources available in the multi-tenant environment.

Additionally, the tenant status provides the system with an efficient way to establish a baseline by which to determine new allocations of resources. According to some disclosed embodiments, it would not be fair for a tenant who only is initially allocated (i.e., the fixed limit of resources guaranteed to the tenant) a low amount of resources, but is already borrowing a higher amount of resources than other tenants, to then be allowed to borrow even more resources from the common pool thereby preventing a tenant who is initially allocated less than their fixed limit of resources to be allocated at least up to their fixed limit of resources or borrow some additional resources. Thus, the tenant status can be used by the system a “quick look” at the distribution of resources across tenants in the multi-tenant environment at any given time and consider the designations of the different tenants when determining how resources should be allocated.

For example, the systems are configured to apply a different borrowing algorithm to each tenant of the plurality of tenants based on a corresponding tenant status determined for each tenant (act 130). Different borrowing algorithms or fairness algorithms are configured to determine new borrowing limits from a common pool of resources for each tenant. By applying different borrowing algorithms to the tenants based on their tenant status, the systems are able to facilitate an improvement in the maximum utilization of resources available in the whole system (by allocating unused resources when they become available) while still maintaining a fair distribution of resources among the different tenants who are using different amounts of resources.

In general, in order to provide a fair allocation of resources, the resource borrowing limits associated with reclaiming or borrowing from the common pool are least restrictive for donating tenants and most restrictive for unfairly borrowing tenants. Notably, the resource borrowing limits for fairly borrowing tenants are more restrictive than limits for donating tenants but less restrictive than limits for unfairly borrowing tenants.

A donating tenant is a tenant who is using less than an initially allotted amount (i.e., fixed limit) of resources within the resource system and who donates the unused resources to a common pool of resources. A fairly borrowing tenant is a tenant who is using all of the initially allotted amount (i.e., fixed limit) of resources within the resource system and is fairly borrowing additional resources from the common pool. An unfairly borrowing tenant is a tenant who is using all of the initially allotted amount (i.e., fixed limit) of resources within the resource system but is unfairly borrowing additional resources from the common pool.

The common pool may maintain a minimum threshold of resources that cannot be borrowed or can be reclaimed by tenants with resource usage below their fixed limit. The system may also include reserving additional resources in the common pool for tenants who are borrowing less than their fair share of resources.

There are several different methods, which will be described in more detail below, for determining whether a tenant is a fairly borrowing tenant or an unfairly borrowing tenant. The systems are also configured to fulfill or reject reclaiming requests and additional borrowing requests based on the tenant status and available resources in the common pool. In some instances, the system is configured with different back-pressures or triggers for forced re-allocations of resources by different borrowers in order to fulfill resource requests from other borrowers with less restrictive borrowing limits associated with the common pool of resources.

In some instances, the shared resources are represented by tokens. For example, when a tenant wishes to make a request to the machine learning model (e.g., LLM), the system will allocate a number of tokens equivalent to the maximum capacity the system could consume in that request. The allocated tokens represent the amount of resources that the tenant is expected to consume in processing the LLM request. If the request requires more tokens than allowed by the new borrowing limit determined for the tenant, the system will deny the request. If the request requires less than or equal to an amount of token allowed by the new borrowing limit, the system will accept the request and allocate any additional tokens to the tenant from the common pool to process the request.

The tokens, however, are just one example representation of the types of resources that can be allocated using the disclosed techniques. In other instances, the resources that are allocated by the disclosed systems using the disclosed techniques comprise a predetermined quantity of memory or storage, processing cycles, bandwidth, duration of a session, virtual machines, services and/or applications. The referenced resources can also include other resources that are not listed above, but which can be quantified and allocated by the disclosed systems to the referenced tenants.

### Example Methods

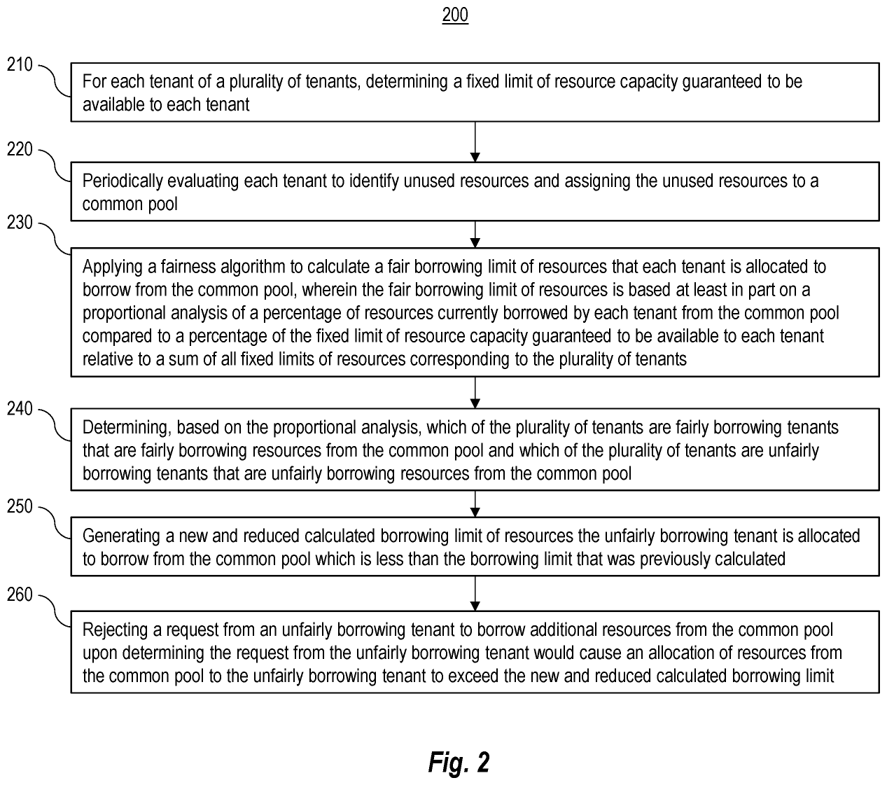

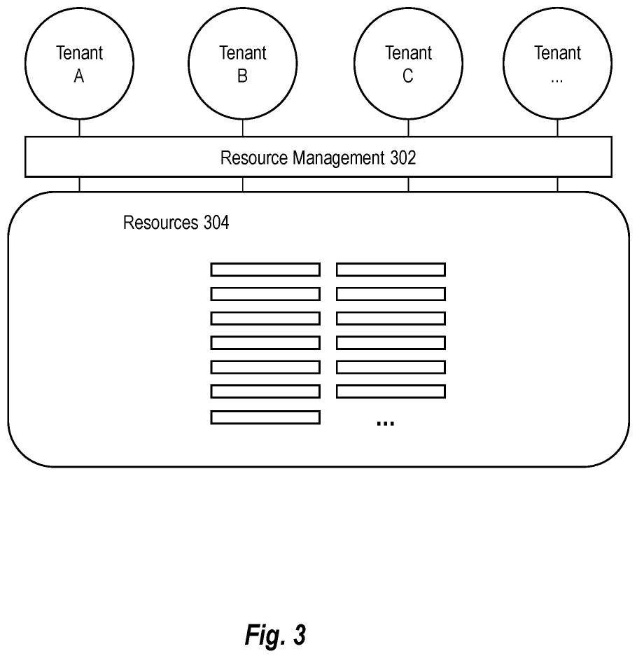

Attention will now be directed to FIG. 2, which illustrates a flow diagram or method 200 that includes various acts (act 210, act 220, and act 230) associated with exemplary methods that can be implemented by computing system 1110 for providing fair allocation of resources in a multi-tenant environment. Notably, the different acts and system components included in FIG. 2 will be further described in reference to FIGS. 3-10 herein.

A first illustrated act is provided for determining a fixed limit of resource capacity guaranteed to be available to each tenant of a plurality of tenants associated with the multi-tenant resource environment (act 210). Determining a fixed limit of resource capacity guaranteed to be available to each tenant is beneficial because it allows the system to determine an amount of resources from the total shared resources available in the multi-tenant environment that could be initially allocated to each tenant. It also provides a way to ensure that each tenant is guaranteed at least that amount of resources at a given time or during a given time frame. This means that every tenant is able to access at least their initial fair share of resources from the system. For example, FIG. 3 shows a multi-tenant resource environment wherein a plurality of tenants (e.g., Tenant A, Tenant B, Tenant C, etc.) have access to resources 304 through resource management 302. It should be appreciated that while resources 304 are shown comprising thirteen resources or discrete capacities of resources, resources 304 may comprise any number of resources or capacities of resources available to any number of tenants.

### Resource Capacity Metrics

Notably, the referenced resources described herein may comprise any type of resource, including hardware and software resources, or even services. In some instances, the resources may be measured in terms of tokens, wherein each token represents a unit of resource capacity needed or allocated to a tenant by a system to process a request by a large language model (LLM), such as a request for the model to process a prompt, and to generate an output such as a response corresponding to the request.

When processing a request, the resources being used are held active for the duration of the request. The resources that were used in processing the request may be released back to the tenant's available limit or the common pool upon completion of the request. Again, the term resource and resource capacity should be broadly construed to include any desired allocation of computational resources, whether a fixed quantity or, alternatively, a flexible quantity needed to process and respond to a request. The corresponding resources can include power, time, applications, computational processing, memory, storage, processors and other hardware components, network bandwidth, and/or any other type of resource that can be utilized by a computing system when processing a request, or any proxy measures or metrics of the above.

When a tenant wishes to make a request to the machine learning model (e.g., LLM), the system will allocate a number of tokens equivalent to the maximum capacity the system could consume in that request. The allocated tokens represent the amount of resources that the tenant is expected to consume in processing the LLM request. For example, an LLM request to score 100 tokens with a max request response length of 200 tokens requires allocating a resource capacity needed to process at least 300 tokens. The tenant holds the allocated resources active for the duration of the request, during which the allocated tokens are considered part of the tenant's active usage of resources. Once the request is completed and the LLM returns a result, the allocated tokens are released, thereby reducing the tenant's active usage of resources.

It should be appreciated that tokens are only one measure of capacity applicable to LLMs since they correlate with the memory utilization of the GPUs running these models, making them good proxies for estimating the memory usage of a tenant. However, the capacity metric (e.g., “resources” or “tokens”) described herein is generalizable to other types of GPU/hardware, software, and machine learning model. As previously described, the referenced resource can be any predetermined quantity of memory or storage, processing cycles, bandwidth, duration of a session, virtual machines, services and/or applications.

In some instances, the referenced resource comprises a resource capacity which refers to the units of memory storage, processing cycles and/or bandwidth needed to process a request. In some instances, the resource capacity refers to a unit of computer processing (e.g., clock speed), like a minimum processing speed to handle a particular request. In some instances, the resource capacity refers to one or more instantiations of a machine learning model that will be used to complete a request. In some instances, the unit of measurement used to describe resource capacity in a multi-tenant shared resource environment will refer to a combination of the aforementioned resources.

### Fixed Limits of Resources

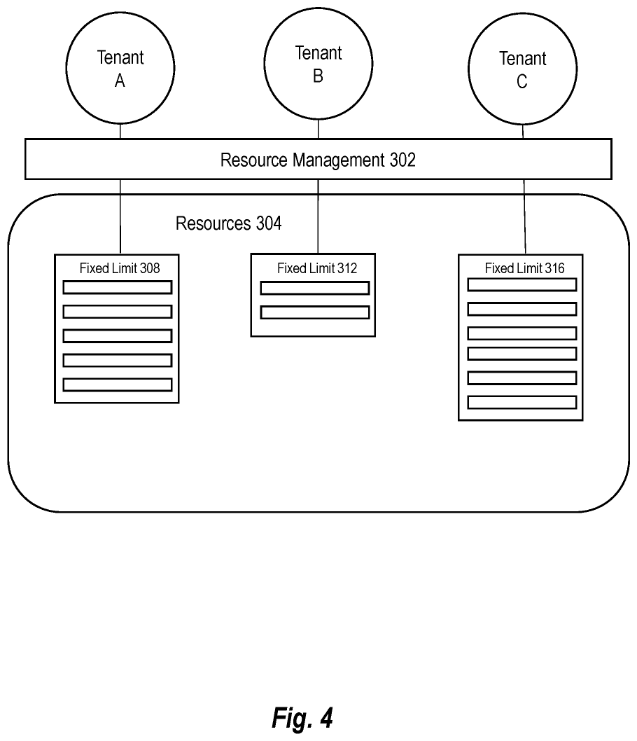

As shown in FIG. 4, a fixed limit of resources is determined for each tenant. A fixed limit of resources is a resource capacity that is guaranteed to be available to a particular tenant. In some instances, the guarantee of resources is associated with a pre-determined margin of time. In some instances, the pre-determined margin of time is relative to a resource request made by the tenant (e.g., five tokens of resources will always be available to Tenant A within two minutes of a request being made by Tenant A). As shown in FIG. 4, the fixed limit 308 for Tenant A is five tokens from resources 304, the fixed limit 312 for Tenant B is two tokens from resources 304, and the fixed limit 316 for Tenant C is six tokens from resources 304. Thus, each tenant is able to initially be allocated one or more resources from resources 304 up to their corresponding fixed limit of resources.

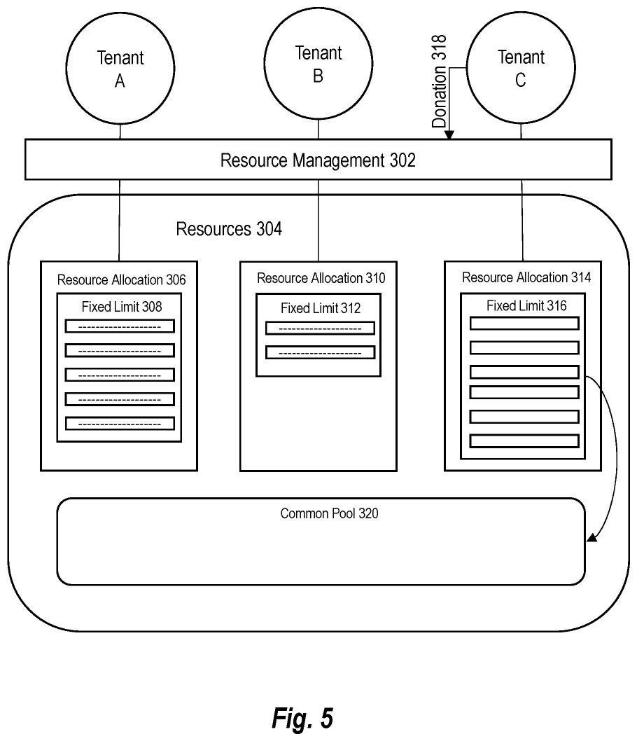

As shown in FIG. 5, Tenant A is allocated (i.e., resource allocation 306) all five of the tokens associated with their fixed limit 308, Tenant B is allocated (i.e., resource allocation 310) all two of the tokens associated with their fixed limit 312, and Tenant C is initially allocated (i.e., resource allocation 314) all six of the tokens associated with their fixed limit 316.

### Unused Resources

Referring back to FIG. 2, systems also periodically evaluate each tenant to identify unused resources and assign the unused resources to a common pool (act 220). By periodically (or continuously) monitoring the system for unused resources, the system is able to maximize resource utilization within the multi-tenant environment by allocating being left unused by one tenant to another tenant who is making more resource requests. In some instances, the system tracks resource usage continuously in real-time and is able to adjust allocation and borrowing limits of resources dynamically in response to changes in the usage of available resources in the multi-tenant environment. By tracking unused resources periodically, the system is able to be tuned according to different time periods, where smaller time periods allow for more continuous monitoring but use more computing power, memory, and processing than larger time periods that still allow for monitoring but use less computing power, memory and processing, In some instances, systems collect information about the amount of resources being used by each tenant's operations, such as the processing power being consumed, the memory being used, the storage being occupied, instantiations of machine learning models, the status of requests being made to machine learning models, or the network bandwidth being utilized. The system is then able to aggregate this data to determine the total active usage of resources for each tenant.

By managing the allocation of resources based on each tenant's actual usage, instead of their potential usage like in conventional systems, the system is better able to maximize the utilization of all resources available in the multi-tenant environment. This process ensures that resources are not left idle in the system when they could be used by other tenants, thereby improving the overall efficiency of the system. Furthermore, by assigning unused resources to the common pool, the system provides a mechanism for different tenants to access additional resources beyond their predetermined limit when they require them, subject to the availability of resources in the pool and the fairness criteria implemented by the system.

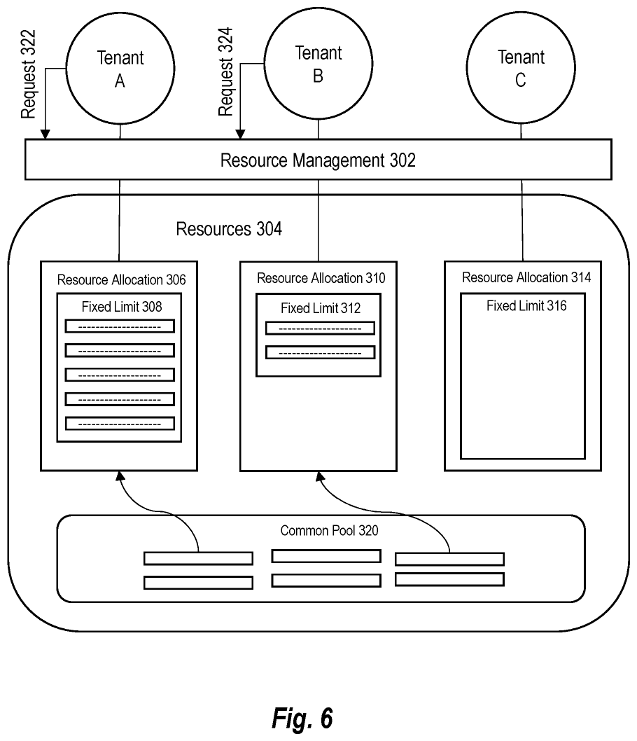

For example, as shown in FIG. 5, Tenant A is using all five of their tokens (i.e., used tokens are indicated by a dashed line throughout the token box, while unused tokens are shown as empty boxes). Tenant B is using all two of their tokens. Tenant C is not using any of their allocated tokens from their fixed limit 316. Here, the system is able to determine that Tenant C is not using some or all of the resources initially allotted or guaranteed to them based on fixed limit 316. The system will then assign any unused resources to the common pool (as shown in FIG. 6). In some instances, Tenant C makes a voluntary donation (e.g., donation 318) to donate all of their unused tokens associated with fixed limit 316 to the common pool 320.

Initial Borrowing from the Common Pool

In some instances, a request to borrow resources from the common pool triggers a re-allocation of unused resources from one or more tenants to the common pool 320 within a certain amount of time of the request. Additionally, or alternatively, unused resources are returned after a pre-determined amount of time of being unused.

As shown in FIG. 6, Tenant A makes a request (e.g., request 322) to borrow additional resources (e.g., one token) from the common pool 320. Tenant B also makes a request (e.g., request 324) to borrow additional resources (e.g., one token) from the common pool 320. While FIG. 6 shows requests for one token being made, it should be appreciated that a tenant can make a request to borrow any amount of tokens from the common pool.

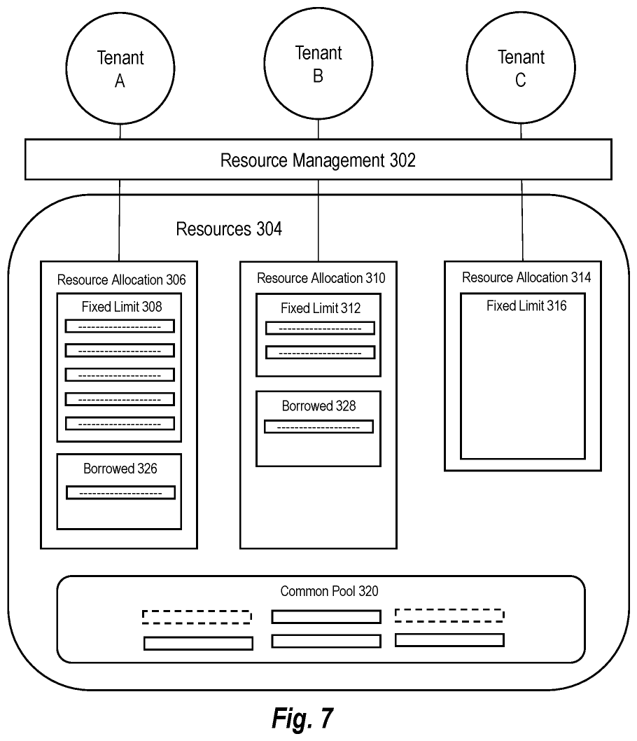

After the additional borrowing requests are fulfilled, FIG. 7 now shows Tenant A using a total of six tokens comprising five tokens within their fixed limit 308 and one token that is borrowed (e.g., borrowed token 326) from common pool 320. Tenant A uses a total of three tokens comprising two tokens from their fixed limit 312 and one token that is borrowed (e.g., borrowed token 328). Tenant C is not using any tokens (i.e. because they previously donated all of their resources corresponding to their fixed limit 316). Common pool 320 now only has four tokens available to be borrowed or reclaimed by the different tenants. The system will then make a determination of whether each tenant is fairly borrowing or unfairly borrowing resources from the common pool.

### Fairness Algorithms/Tenant Status

For example, referring back to FIG. 2, systems apply a fairness algorithm to calculate a fair borrowing limit of resources that each tenant is allocated to borrow from the common pool (act 230). By applying a fairness algorithm, or calculation method, to calculate a fair borrowing limit of resources for each tenant, the system is able to balance maximizing utilization (by monitoring for and allocating unused resources) without sacrificing fairness in providing availability of resources to different tenants. The fair borrowing limit of resources is calculated based at least in part on a proportional analysis of a percentage of resources currently borrowed by each tenant from the common pool compared to a percentage of the fixed limit of resource capacity guaranteed to be available to each tenant relative to a sum of all fixed limits of resources corresponding to the plurality of tenants.

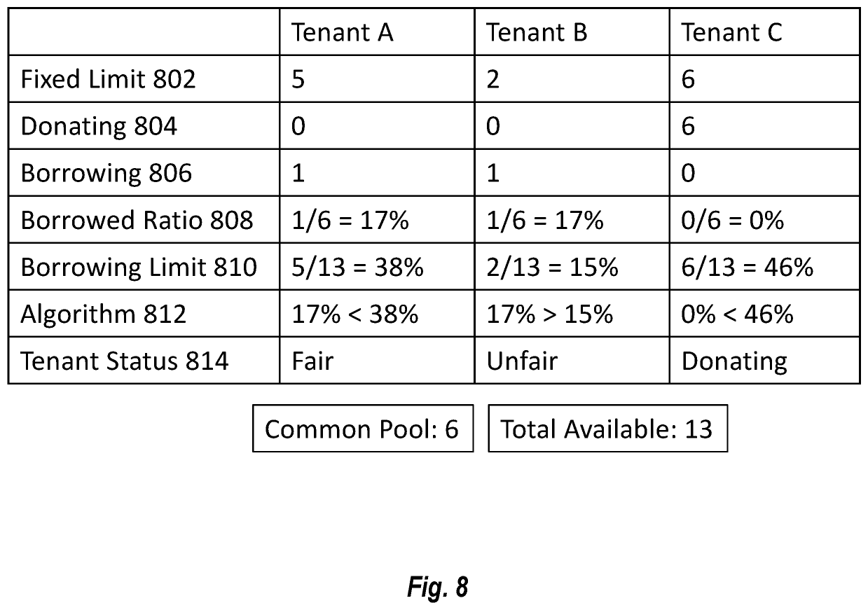

For example, as shown in FIG. 8, the system keeps track of each tenant, namely, a fixed limit 802, tokens being donated (i.e., donating 804), tokens being borrowed (borrowing 806), a borrowed ratio based on the token being borrowed relative to the tokens available in the common pool. The systems also determine a borrowing limit 810 for each tenant based on the fixed limit 802 relative to the total available tokens in resources 304.

Referring back to FIG. 2, systems determine, based on the proportional analysis, which of the plurality of tenants are fairly borrowing tenants that are fairly borrowing resources from the common pool and which of the plurality of tenants are unfairly borrowing tenants that are unfairly borrowing resources from the common pool (act 240). As described above, By identifying whether a tenant is a donating tenant, a fairly borrowing tenant, or an unfairly borrowing tenant, the system is able to better determine the allocation or re-allocation of resources that are available to each tenant resulting in (i) the improved fair allocation between all the tenants and (ii) the optimization of the system to achieve maximum utilization of all resources available in the multi-tenant environment. The tenant status is useful in providing the system a “quick look” at the distribution of resources across tenants in the multi-tenant environment at any given time.

Thus, as shown in FIG. 8, based on a fair algorithm (e.g., algorithm 812), the system determines a tenant status 814. In some instances, as described above, the fairness algorithm is based on comparing the borrowed ratio 808 against the borrowing limit 810. If the borrowed ratio 808 is less than or equal to the borrowing limit 810, the tenant is considered to be a fairly borrowing tenant. If the borrowed ratio 808 is greater than the borrowing limit 810, the tenant is considered to be an unfairly borrowing tenant. If the tenant is not using any of their fixed limit or less than their fixed limit, they are considered a donating tenant.

In particular, because Tenant A's borrowed ratio 808 is less than Tenant A's borrowing limit (e.g., 17%<38%), Tenant A's status is fair. Because Tenant B's borrowed ratio 808 is greater than Tenant B's borrowing limit (e.g., 17%>15%), Tenant B's status is unfair. Because Tenant C is using less than their fixed limit (in this case, none of their fixed limit), Tenant C is a donating tenant.

After determining tenant status, the systems are configured to determine a new resource borrowing limit corresponding to the amount of additional resources each different tenant can request to borrow (or reclaim if they are a donating tenant) from the common pool 320 based on their respective tenant status. For example, referring back to FIG. 2, systems generate a new calculated borrowing limit of resources an unfairly borrowing tenant (or fairly borrowing tenant or donating tenant) is allocated to borrow from the common pool which is less than the fair borrowing limit of resources that was previously calculated (act 250). By applying different borrowing algorithms to the tenants based on their tenant status, the systems are able to facilitate an improvement in the maximum utilization of resources available in the whole system (by allocating unused resources when they become available) while still maintaining a fair distribution of resources among the different tenants who are using different amounts of resources.

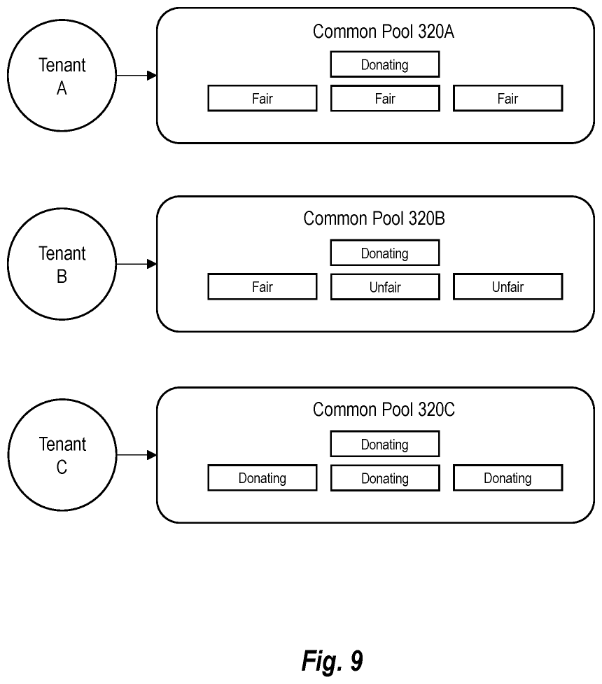

For example, because Tenant C is a donating tenant, the system determines that Tenant C can reclaim up to their fixed limit 316 of resources. As illustrated in FIG. 9, all four of the tokens currently available in the common pool (e.g., common pool 320C) are available to be reclaimed by Tenant C.

If Tenant C makes a request to reclaim more than the currently available total of tokens in the common pool, the system may force a re-allocation of unused resources from a different tenant or force a return of any borrowed tokens from a borrowing tenant. In some instances, where a forced return is required to fulfill the donating tenant's request, the system will first return borrowed tokens from unfairly borrowing tenants, and then borrowed tokens from fairly borrowing tenants, if needed. In some instances, the forced return is immediate when the request from the donating tenant is received. Alternatively, the forced return occurs within a predetermined time margin associated with the donating tenant's fixed limit 316 (or guaranteed resource capacity). Alternatively, the forced return occurs after the borrowing tenant's results are generated from using the borrowed tokens (i.e. after they are done using the tokens to generate output from a machine learning model). If a forced return is needed, Tenant C is able to begin using any tokens already available in the common pool before the forced return occurs to provide the full amount of tokens requested, up to their fixed limit.

It will be appreciated that many techniques can be implemented for forcing the return of resources. Some of these techniques are resource dependent. For example, when resources comprise storage, the system may allocate leases to the tenants for the reserved or allocated storage. These leases may establish control to the tenant for read and/or write locks to that storage. The system can force the return of the resources by revoking the leases to that storage, such that the tenant no longer has control over the read and write locks to that storage.

Alternatively, or additionally, the system can rename the namespace of the allocated storage and can provide a new name for the namespace of that storage resource to another tenant that is allocated the revoked and returned storage. This may also include overwriting data or otherwise cleaning the referenced storage before it is reallocated to a new tenant.

In another embodiment, when the resources comprise bandwidth, the system can force a return of resources by restricting the bandwidth allocated to the tenant that is having its allocated resources revoked. This essentially forces a return of bandwidth capacity to the system to be reallocated to new tenants. The system may include, for example, a network gateway and/or communicate with a third-party network gateway that manages and meters the flow of network traffic to different tenants. Tables utilized by the network gateway for tracking the allocation of bandwidth can be updated to reflect changes in the allocation of the bandwidth that is metered to the different tenants, such as when resources are first allocated, as well as when a forced return of resources is implemented.

In yet another example, when the resources comprise instances of an application or service that this allocated to the tenants, the system can issue licenses of use (with necessary authentication and/or validation credentials) to enable the tenants to utilize the applications and services they are allocated. Then, when forcing a return of the resources, the system can revoke the enabling licenses that are necessary for the tenants to utilize the applications and services.

By enabling the system to force the return of resources, in some instances, and by allowing donating tenants to reclaim resources, the system ensures that resources are not hoarded by tenants who do not currently require the fixed limit of resources or are borrowing above their fixed limit, or above their borrowing limit. This also enables the system to dynamically expand the pool of available resources, making these resources available to other tenants who may require additional resources, like donating tenants or fairly borrowing tenants. The forced return also provides a backpressure to any tenants who are using resources above their fixed limit or borrowing above their borrowing limit, by ensuring that all tenants have fair access to the resources available in the multi-tenant environment.

The system also determines a new borrowing limit for Tenant A, who is a fairly borrowing tenant. In some instances, the system reserves a portion of the resources available in the common pool (e.g., common pool 320A) for the donating tenant (e.g., at least one token, in some instances, as shown in FIG. 9). Thus, Tenant A is able to borrow an additional three tokens from the common pool.

The borrowing limit for Tenant B is more restrictive than the borrowing limit for Tenant A because they are an unfairly borrowing tenant with respect to the common pool. When considering requests from an unfairly borrowing tenant, the system reserves a first portion of the common pool resources for any donating tenants and a second portion of the common pool resources for any fairly borrowing tenants (i.e., at least one token for Tenant C who is a donating tenant and at least one token for Tenant A who is a fairly borrowing tenant). In some instances, the system reserves at least one token for each donating or fairly borrowing tenant in the multi-tenant environment. Thus, as shown in FIG. 9, Tenant B is able to borrow an additional two tokens out of the four available in the common pool 320B.

By reserving additional resources for tenants who are borrowing less than their fair share of resources, this system configuration helps to maintain fairness in the allocation of resources in the multi-tenant environment. It ensures that tenants have access to their fair share of resources, thereby preventing resource monopolization by tenants with larger predetermined limits and ensuring that tenants with smaller predetermined limits have access to the resources they require. This contributes to the overall efficiency and effectiveness of the system in managing shared resources in a multi-tenant environment.

In some instances, if Tenant B requests more than the two available tokens, the system will reject the borrowing request, or will only fulfill the request up to the new borrowing limit (i.e., two tokens). For example, referring back to FIG. 2, systems will reject a request from an unfairly borrowing tenant to borrow additional resources from the common pool upon determining the request from the unfairly borrowing tenant would cause an allocation of resources from the common pool to the unfairly borrowing tenant to exceed the new calculated borrowing limit (260). By rejecting requests that would exceed the new calculated borrowing limit, the system ensures that the fairly borrowing tenants and donating tenants will still have access to reclaim or borrowing resources and prevents any one tenant from borrowing all of the resources.

By determining fairness in borrowing resources in this manner, the system ensures that resources are efficiently utilized and fairly allocated among the tenants. It prevents tenants with larger predetermined limits from monopolizing the resources, while also ensuring that tenants with smaller predetermined limits have access to the resources they require. This contributes to the overall efficiency and effectiveness of the system in managing shared resources in a multi-tenant environment.

### Improved Fairness Algorithms

Some embodiments disclosed herein are directed to utilizing an improved fairness algorithm that determines new borrowing limits based on the fixed limits corresponding to borrowing tenants, not all of the tenants. For example, in such embodiments, systems apply a fairness algorithm to calculate a fair borrowing limit of resources that each tenant is allocated to borrow from the common pool. The fair borrowing limit of resources is based at least in part on a proportional analysis of a percentage of resources currently borrowed by each tenant from the common pool compared to a percentage of the fixed limit of resource capacity guaranteed to be available to each tenant relative to a sum of all fixed limits of resources corresponding to the one or more borrowing tenants.

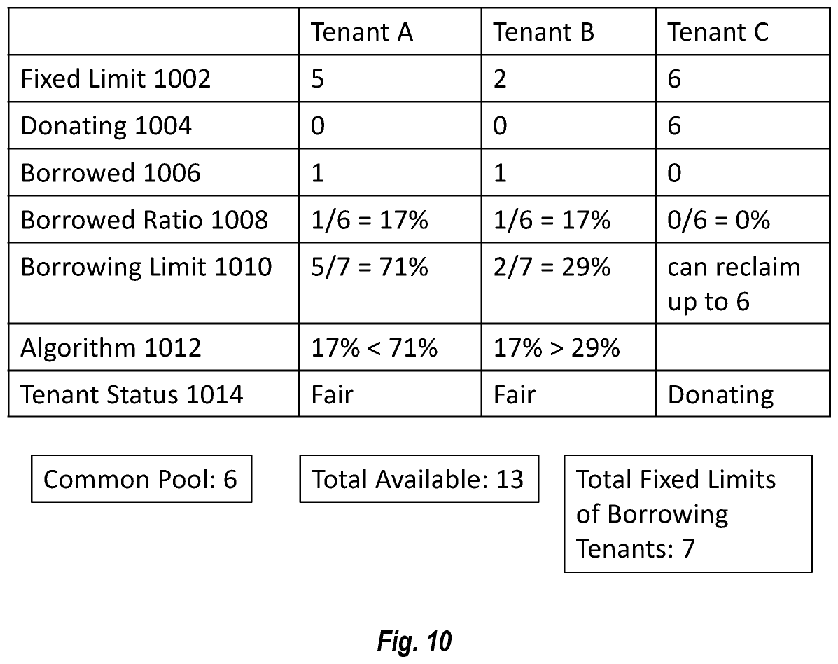

For example, as shown in FIG. 10, the system keeps track of each tenant, namely, a fixed limit 1002, tokens being donated (i.e., donating 1004), tokens being borrowed (borrowing 1006), a borrowed ratio based on the token being borrowed relative to the tokens available in the common pool. The borrowed ratio for Tenant A is 1 borrowed token relative to six tokens initially in the common pool 320 (i.e., borrowed ratio=17%). The borrowed ratio for Tenant B is the same as Tenant A because Tenant B is also borrowing 1/6 tokens from the common pool 320. The borrowed ratio for Tenant C is 0% because Tenant C is not borrowing any tokens. The systems also determine a borrowing limit 1010 for each tenant based on the fixed limit 1002 relative to the total fixed limits of resources corresponding to borrowing tenants. The borrowing limit for Tenant A is 29% (e.g., the five tokens associated with Tenant A's fixed limit relative to the 7 tokens corresponding to the sum of the fixed limits for borrowing tenants). The sum of the fixed limits for the borrowing tenants includes the five tokens from Tenant's A fixed limit and the two tokens from Tenant B's fixed limit.

Then, systems determine based on the proportional analysis of the borrowed ratio to the borrowing limit, which of the plurality of tenants are fairly borrowing tenants that are fairly borrowing resources from the common pool and which of the plurality of tenants are unfairly borrowing tenants that are unfairly borrowing resources from the common pool. As shown in FIG. 10, based on an improved fair algorithm (e.g., algorithm 1012), the system determines a tenant status 1014. In some instances, as described above, the fairness algorithm is based on comparing the borrowed ratio 1008 against the borrowing limit 1010. If the borrowed ratio 1008 is less than or equal to the borrowing limit 1010, the tenant is considered to be a fairly borrowing tenant. If the borrowed ratio 1008 is greater than the borrowing limit 1010, the tenant is considered to be an unfairly borrowing tenant. If the tenant is not using any of their fixed limit or less than their fixed limit, they are still considered a donating tenant.

According to algorithm 1012, because Tenant A's borrowed ratio 1008 is less than Tenant A's borrowing limit (e.g., 17%<38%), Tenant A's status is fair. Because Tenant B's borrowed ratio 808 is also less than Tenant B's new borrowing limit (e.g., 17%>29%), Tenant B's status is also fair. Because Tenant C is using less than their fixed limit (in this case, none of their fixed limit), Tenant C is a donating tenant.

Each tenant can then borrow additional resources from the common pool based on a new borrowing limit determined by applying the fairness algorithms to each tenant for the different tenant statuses. Thus, according to algorithm 1012, because Tenant A and Tenant B are both fairly borrowing tenants, either Tenant A or Tenant B would be able to borrow an additional three tokens from the available four tokens in the common pool 320. Some resources (e.g., in some instances, at least one token) would still be reserved for Tenant C who is a donating tenant.

### Example Computing Systems

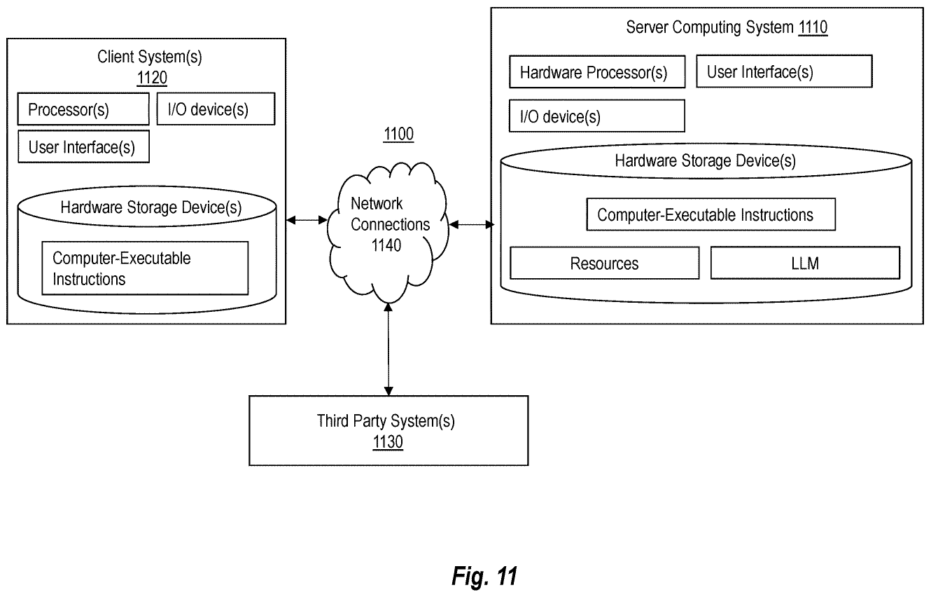

Attention will now be directed to FIG. 11, which illustrates the computing system 1110 as part of a computing environment 1100 that includes client system(s) 1120 and third-party system(s) 1130 in communication (via a network 1140) with the computing system 1110. As illustrated, computing system 1110 is a server computing system configured to compile, modify, and implement one or more machine learning models configured to provide a fair allocation of resources in a multi-tenant resource environment.

The computing system 1110, for example, includes one or more processor(s) (such as one or more hardware processor(s) and one or more hardware storage device(s) storing computer-readable instructions. One or more of the hardware storage device(s) is able to house any number of data types and/or any number of computer-executable instructions by which the computing system 1110 is configured to implement one or more aspects of the disclosed embodiments when the computer-executable instructions are executed by the one or more hardware processor(s). The hardware storage device(s) is/are configured to comprise and/or access different resources that can be shared and allocated between different tenants for fulfilling model requests using machine learning models (e.g., LLMs).

The computing system 1110 is also shown including user interface(s) and input/output (I/O) device(s) (such as audio inputs like microphones and other audio input devices, and audio outputs such as speakers and other audio output devices).

As shown in FIG. 11, the hardware storage device(s) is shown as a single storage unit. However, it will be appreciated that the hardware storage device(s) can be a distributed storage that is distributed to several separate and sometimes remote systems and/or third-party system(s). Computing system 1110 can also comprise a distributed system with one or more of the components of computing system 1110 being maintained/run by different discrete systems that are remote from each other and each performs different tasks. In some instances, a plurality of distributed systems performs similar and/or shared tasks for implementing the disclosed functionality, such as in a distributed cloud environment.

The computing system is in communication with client system(s) 1120 comprising one or more processor(s), one or more user interface(s), one or more I/O device(s), one or more sets of computer-executable instructions, and one or more hardware storage device(s).

The computing system is also in communication with third-party system(s). It is anticipated that, in some instances, the third-party system(s) 1130 further comprise databases housing additional resources, for example, resources not included in local storage. Additionally, or alternatively, the third-party system(s) 1130 includes machine learning systems external to the computing system 1110.

Embodiments of the present invention may comprise or utilize a special-purpose or general-purpose computer (e.g., computing system 1110) including computer hardware, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media (e.g., hardware storage device(s) of FIG. 11) that store computer-executable/computer-readable instructions are physical hardware storage media/devices that exclude transmission media. Computer-readable media that carry computer-executable instructions or computer-readable instructions in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 1140 of FIG. 11) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

### Aspects of the Disclosed Embodiments

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

Various aspects of the present subject matter are set forth below, in review of, and/or in supplementation to, the embodiments described thus far, with the emphasis here being on the interrelation and interchangeability of the following embodiments related to either systems or methods disclosed herein. In other words, an emphasis is on the fact that each feature of the embodiments can be combined with each and every other feature unless explicitly stated otherwise or logically implausible.

In some aspects, the techniques described herein relate to a method for managing shared resources in a multi-tenant environment, the method including: for each tenant of a plurality of tenants, determining a fixed limit of resource capacity guaranteed to be available to each tenant; periodically evaluating each tenant to identify unused resources and assigning the unused resources to a common pool; calculating a fair borrowing limit of resources that each tenant is allocated to borrow from the common pool, wherein the fair borrowing limit of resources is based at least in part on a proportional analysis of a percentage of resources currently borrowed by each tenant from the common pool compared to a percentage of the fixed limit of resource capacity guaranteed to be available to each tenant relative to a sum of all fixed limits of resources corresponding to the plurality of tenants; determining, based on the proportional analysis, which of the plurality of tenants are fairly borrowing tenants that are fairly borrowing resources from the common pool and which of the plurality of tenants are unfairly borrowing tenants that are unfairly borrowing resources from the common pool; generating a new calculated borrowing limit of resources an unfairly borrowing tenant is allocated to borrow from the common pool which is less than the fair borrowing limit of resources that was previously calculated; and rejecting a request from an unfairly borrowing tenant to borrow additional resources from the common pool upon determining the request from the unfairly borrowing tenant would cause an allocation of resources from the common pool to the unfairly borrowing tenant to exceed the new calculated borrowing limit.

In some aspects, the techniques described herein relate to a method, further including reserving a first minimum quantity by donating tenants.

In some aspects, the techniques described herein relate to a method, further including reserving a second minimum quantity of resources in the common pool to be borrowed by fairly borrowing tenants.

In some aspects, the techniques described herein relate to a method, wherein applying the fairness algorithm to calculate the fair borrowing limit of resources that each tenant is allocated to borrow from the common pool is based at least in part on a different proportional analysis of the percentage of resources currently borrowed by each tenant from the common pool compared to a different percentage of the fixed limit of resource capacity guaranteed to be available to each tenant relative to a sum of fixed limits of resources corresponding to one or more borrowing tenants of the plurality of tenants.

In some aspects, the techniques described herein relate to a method, further including: receiving a request from a donating tenant to reclaim resources from the common pool; determining that the common pool has insufficient resources to fulfill the request from the donating tenant; upon determining that the common pool has insufficient resources to fulfill the request from the donating tenant, forcing a return of resources from one or more borrowing tenants back to the common pool; and fulfilling the request from the donating tenant by allocating resources from the common pool to the donating tenant.

In some aspects, the techniques described herein relate to a method, wherein the donating tenant can request to reclaim up to a fixed limit of resources corresponding to the donating tenant from the common pool for triggering a forced return of resources from the one or more borrowing tenants.

In some aspects, the techniques described herein relate to a computing system for managing shared resources in a multi-tenant environment, the computing system including: a processor; and a hardware storage device storing computer-executable instructions that are executable by the processor to cause the computing system to: for each tenant of a plurality of tenants, determine a fixed limit of resource capacity guaranteed to be available to each tenant; periodically evaluate each tenant to identify unused resources and assign the unused resources to a common pool; calculating a fair borrowing limit of resources that each tenant is allocated to borrow from the common pool, wherein the fair borrowing limit of resources is based at least in part on a proportional analysis of a percentage of resources currently borrowed by each tenant from the common pool compared to a percentage of the fixed limit of resource capacity guaranteed to be available to each tenant relative to a sum of all fixed limits of resources corresponding to the plurality of tenants; determine, based on the proportional analysis, which of the plurality of tenants are fairly borrowing tenants that are fairly borrowing resources from the common pool and which of the plurality of tenants are unfairly borrowing tenants that are unfairly borrowing resources from the common pool; generate a new calculated borrowing limit of resources an unfairly borrowing tenant is allocated to borrow from the common pool which is less than the fair borrowing limit that was previously calculated; and reject a request from an unfairly borrowing tenant to borrow additional resources from the common pool upon determining the request from the unfairly borrowing tenant would cause an allocation of resources from the common pool to the unfairly borrowing tenant to exceed the new calculated borrowing limit.

In some aspects, the techniques described herein relate to a computing system, wherein the computing system is further caused to reserve a first minimum quantity by donating tenants.

In some aspects, the techniques described herein relate to a computing system, wherein the computing system is further caused to reserve a second minimum quantity of resources in the common pool to be borrowed by fairly borrowing tenants.

In some aspects, the techniques described herein relate to a computing system, wherein applying the fairness algorithm to calculate the fair borrowing limit of resources that each tenant is allocated to borrow from the common pool is based at least in part on a different proportional analysis of the percentage of resources currently borrowed by each tenant from the common pool compared to a different percentage of the fixed limit of resource capacity guaranteed to be available to each tenant relative to a sum of fixed limits of resources corresponding to one or more borrowing tenants of the plurality of tenants.

In some aspects, the techniques described herein relate to a computing system, wherein the computing system is further caused to: receiving a request from a fairly borrowing tenant to borrow additional resources from the common pool; determining that the common pool has insufficient resources to fulfill the request from the fairly borrowing tenant; forcing a return of resources from an unfairly borrowing tenant back to the common pool; and fulfilling the request from the fairly borrowing tenant to borrow additional resources from the common pool.

In some aspects, the techniques described herein relate to a computing system, wherein the computing system is further caused to: identifying a result being returned by a machine learning model based on utilizing a set of resources being used by an unfairly borrowing tenant associated with the machine learning model; and subsequent to identifying the result being returned, forcing a return of a portion of the set of unused resources allocated to the unfairly borrowing tenant back to the common pool such that the tenant that was unfairly borrowing is no longer using resources above the fair borrowing limit of resources for that tenant.

In some aspects, the techniques described herein relate to a method for managing shared resources in a multi-tenant environment, the method including: identifying a plurality of tenants participating in the multi-tenant environment; for each tenant of the plurality of tenants, determining a tenant status as a donating tenant, a fairly borrowing tenant, or an unfairly borrowing tenant; and applying a different borrowing algorithm to each tenant of the plurality of tenants based on a corresponding tenant status determined for each tenant, wherein different borrowing algorithms are configured to determine different resource borrowing limits from a common pool of resources for each tenant.

In some aspects, the techniques described herein relate to a method, further including prior to determining a tenant status, determining a fixed limit of resources guaranteed to be available to each tenant of the plurality of tenants.

In some aspects, the techniques described herein relate to a method, wherein the tenant status is determined to be the donating tenant when a particular tenant of the plurality of tenants is donating some or all of a fixed limit of resources guaranteed to be available to the particular tenant to the common pool.

In some aspects, the techniques described herein relate to a method, wherein the tenant status is determined to be the fairly borrowing tenant or unfairly borrowing tenant based at least in part on a proportional analysis of a percentage of resources currently borrowed by a particular tenant from the common pool compared to a percentage of a fixed limit of resource capacity guaranteed to be available to the particular tenant relative to a sum of all fixed limits of resources corresponding to the plurality of tenants.

In some aspects, the techniques described herein relate to a method, wherein the tenant status is determined to be the fairly borrowing tenant or unfairly borrowing tenant based at least in part on a proportional analysis of a percentage of resources currently borrowed by a particular tenant from the common pool compared to a percentage of a fixed limit of resource capacity guaranteed to be available to the particular tenant relative to a sum of all fixed limits of resources corresponding to one or more borrowing tenants.

In some aspects, the techniques described herein relate to a method, wherein a first resource borrowing limit corresponding to an unfairly borrowing tenant is less than a second resource borrowing limit corresponding to a fairly borrowing tenant.

In some aspects, the techniques described herein relate to a method, wherein a third resource borrowing limit corresponding to a donating tenant is greater than the second resource borrowing limit.

In some aspects, the techniques described herein relate to a method, further including: rejecting a request from an unfairly borrowing tenant to borrow additional resources from the common pool upon determining the request from the unfairly borrowing tenant would cause an amount of resources available in the common pool to drop below a minimum threshold.

It should be noted that all features, elements, components, functions, and steps described with respect to any embodiment provided herein are intended to be freely combinable and substitutable with those from any other embodiment. If a certain feature, element, function, or step is described with respect to only one embodiment, it should be understood that each feature, element, function, or step can be used with any other embodiment described herein.

What is claimed is:

1. A method for managing shared resources in a multi-tenant environment, the method comprising:
for each tenant of a plurality of tenants, determining a fixed limit of resource capacity guaranteed to be available to each tenant;
periodically evaluating each tenant to identify unused resources and assigning the unused resources to a common pool;
calculating a fair borrowing limit of resources that each tenant is allocated to borrow from the common pool, wherein the fair borrowing limit of resources is based at least in part on a proportional analysis of a percentage of resources currently borrowed by each tenant from the common pool compared to a percentage of the fixed limit of resource capacity guaranteed to be available to each tenant relative to a sum of all fixed limits of resources corresponding to the plurality of tenants;
determining, based on the proportional analysis, which of the plurality of tenants are fairly borrowing tenants that are fairly borrowing resources from the common pool at or below the calculated fair borrowing limit of resources and which of the plurality of tenants are unfairly borrowing tenants that are unfairly borrowing resources from the common pool above the calculated fair borrowing limit of resources;
generating a new calculated borrowing limit of resources an unfairly borrowing tenant is allocated to borrow from the common pool which is less than the fair borrowing limit of resources that was previously calculated; and
rejecting a request from an unfairly borrowing tenant to borrow additional resources from the common pool upon determining the request from the unfairly borrowing tenant would cause an allocation of resources from the common pool to the unfairly borrowing tenant to exceed the new calculated borrowing limit.

2. The method of claim 1, further comprising reserving a first minimum quantity of resources in the common pool to be reclaimed by donating tenants.

3. The method of claim 1, further comprising reserving a second minimum quantity of resources in the common pool to be borrowed by fairly borrowing tenants.

4. The method of claim 1, wherein calculating the fair borrowing limit of resources that each tenant is allocated to borrow from the common pool is based at least in part on a different proportional analysis of the percentage of resources currently borrowed by each tenant from the common pool compared to a different percentage of the fixed limit of resource capacity guaranteed to be available to each tenant relative to a sum of fixed limits of resources corresponding to one or more borrowing tenants of the plurality of tenants.

5. The method of claim 1, further comprising:
receiving a request from a donating tenant to reclaim resources from the common pool;
determining that the common pool has insufficient resources to fulfill the request from the donating tenant;
upon determining that the common pool has insufficient resources to fulfill the request from the donating tenant, forcing a return of resources from one or more borrowing tenants back to the common pool; and
fulfilling the request from the donating tenant by allocating resources from the common pool to the donating tenant.

6. The method of claim 5, wherein the donating tenant requests to reclaim up to a fixed limit of resources corresponding to the donating tenant from the common pool for triggering a forced return of resources from the one or more borrowing tenants.

7. A computing system for managing shared resources in a multi-tenant environment, the computing system comprising:
a processor; and
a hardware storage device storing computer-executable instructions that are executable by the processor to cause the computing system to:
for each tenant of a plurality of tenants, determine a fixed limit of resource capacity guaranteed to be available to each tenant;
periodically evaluate each tenant to identify unused resources and assign the unused resources to a common pool;
calculating a fair borrowing limit of resources that each tenant is allocated to borrow from the common pool, wherein the fair borrowing limit of resources is based at least in part on a proportional analysis of a percentage of resources currently borrowed by each tenant from the common pool compared to a percentage of the fixed limit of resource capacity guaranteed to be available to each tenant relative to a sum of all fixed limits of resources corresponding to the plurality of tenants;
determine, based on the proportional analysis, which of the plurality of tenants are fairly borrowing tenants that are fairly borrowing resources from the common pool at or below the calculated fair borrowing limit and which of the plurality of tenants are unfairly borrowing tenants that are unfairly borrowing resources from the common pool above the calculated fair borrowing limit;
generate a new calculated borrowing limit of resources an unfairly borrowing tenant is allocated to borrow from the common pool which is less than the fair borrowing limit that was previously calculated; and
reject a request from an unfairly borrowing tenant to borrow additional resources from the common pool upon determining the request from the unfairly borrowing tenant would cause an allocation of resources from the common pool to the unfairly borrowing tenant to exceed the new calculated borrowing limit.

8. The computing system of claim 7, wherein the computing system is further caused to:
reserve a first minimum quantity of resources in the common pool to be reclaimed by donating tenants.

9. The computing system of claim 7, wherein the computing system is further caused to:
reserve a second minimum quantity of resources in the common pool to be borrowed by fairly borrowing tenants.

10. The computing system of claim 7, wherein calculating the fair borrowing limit of resources that each tenant is allocated to borrow from the common pool is based at least in part on a different proportional analysis of the percentage of resources currently borrowed by each tenant from the common pool compared to a different percentage of the fixed limit of resource capacity guaranteed to be available to each tenant relative to a sum of fixed limits of resources corresponding to one or more borrowing tenants of the plurality of tenants.

11. The computing system of claim 7, wherein the computing system is further caused to:
receive a request from a fairly borrowing tenant to borrow additional resources from the common pool;
determine that the common pool has insufficient resources to fulfill the request from the fairly borrowing tenant;
force a return of resources from an unfairly borrowing tenant back to the common pool; and
fulfill the request from the fairly borrowing tenant to borrow additional resources from the common pool.

12. The computing system of claim 7, wherein the computing system is further caused to:
identify a result being returned by a machine learning model based on utilizing a set of resources allocated to an unfairly borrowing tenant associated with the machine learning model; and
subsequent to identifying the result being returned, force a return of a portion of the set of resources allocated to the unfairly borrowing tenant back to the common pool such that the tenant that was unfairly borrowing is no longer using resources above the fair borrowing limit of resources for that tenant.

13. A method for managing shared resources in a multi-tenant environment, the method comprising:
identifying a plurality of tenants participating in the multi-tenant environment;
for each tenant of the plurality of tenants, determining a tenant status as a donating tenant that is donating some or all of a fixed limit of resources guaranteed to be available to the particular tenant, a fairly borrowing tenant that is borrowing resources at or below a previously calculated fair borrowing limit, or an unfairly borrowing tenant that is borrowing resources above previously calculated fair borrowing limit; and
applying a different borrowing algorithm to each tenant of the plurality of tenants based on a corresponding tenant status determined for each tenant, wherein different borrowing algorithms are configured to determine new borrowing limits associated with borrowing shared resources from a common pool in the multi-tenant environment.

14. The method of claim 13, wherein the shared resources in the multi-tenant environment are represented by tokens.

15. The method of claim 14, further comprising:
receiving a request from a particular tenant to be processed by a large language model;
determining a maximum capacity of a system associated with the multi-tenant environment that will be needed to process the request;
determining that allocating tokens for meeting maximum capacity that will be needed to process the request does not exceed a new borrowing limit determined for the particular tenant; and
allocating a number of tokens to the particular tenant for processing the request, wherein the allocated tokens represent an amount of resources from the shared resources that the particular tenant is expected to consume in processing the request.

16. The method of claim 13, wherein the tenant status is determined to be the fairly borrowing tenant or unfairly borrowing tenant based at least in part on a proportional analysis of a percentage of resources currently borrowed by a particular tenant from the common pool compared to a percentage of a fixed limit of resource capacity guaranteed to be available to the particular tenant relative to a sum of all fixed limits of resources corresponding to the plurality of tenants.

17. The method of claim 13, wherein the tenant status is determined to be the fairly borrowing tenant or unfairly borrowing tenant based at least in part on a proportional analysis of a percentage of resources currently borrowed by a particular tenant from the common pool compared to a percentage of a fixed limit of resource capacity guaranteed to be available to the particular tenant relative to a sum of all fixed limits of resources corresponding to one or more borrowing tenants.

18. The method of claim 13, wherein a first resource borrowing limit corresponding to an unfairly borrowing tenant is less than a second resource borrowing limit corresponding to a fairly borrowing tenant.

19. The method of claim 18, wherein a third resource borrowing limit corresponding to a donating tenant is greater than the second resource borrowing limit.

20. The method of claim 13, further comprising:
rejecting a request from an unfairly borrowing tenant to borrow additional resources from the common pool upon determining the request from the unfairly borrowing tenant would cause an amount of resources available in the common pool to drop below a minimum threshold.
